(19) United States
(12) Patent Application Publication
(10) Pub. No.: US 2005/0173837 A1
(43) Pub. Date: Aug. 11, 2005

(54) Method for manufacturing building elements

(76) Inventors: Edouard Serras, Neuilly-Sur-Seine (FR); Jean-Marie Gaillard, Limoges (FR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/657,679

(22) Filed: Sep. 8, 2003

Related U.S. Application Data
(63) Continuation of application No. PCT/FR02/00831, filed on Mar. 7, 2002.

(30) Foreign Application Priority Data
Mar. 8, 2001 (FR) FR 0103350

(51) Int. Cl. B28B 3/00

(52) U.S. Cl. 264/333

(57) ABSTRACT

A method for manufacturing a building element based on plaster consists of introducing a mixture of plaster, a granular filler and water in a mold (10) with rigid non deformable walls (12, 14, 16), compressing said mixture into the mold at a pressure that is greater than or equal to a threshold value beyond which plaster crystallization is prevented by increasing its solubility in water, then causing rapid crystallization of the plaster by reducing or ceasing compression of the mixture.

The invention relates to a method for manufacturing building elements from a mixture of plaster, water and an optional granular filler.

European patents EP-A-0 290 571 and EP-A-0 619 773 in particular describe a known method of that type, which essentially consists of placing a mixture of plaster, sand and water in a mold in the shape of the element to be manufactured, packing the mixture into the mold and then opposing any volume increase in the mold as the plaster sets. The volume expansion of the plaster that occurs as it hydrates and crystallizes is thus opposed, resulting in densification of the crystalline matrix of the plaster in the manufactured element. Such molded elements are used in building when unmolded and have mechanical and physical properties that are equivalent to building stone. They can be assembled without joints because of their dimensional accuracy, and their appearance resembles that of dressed stone, which renders any external coating superfluous.

One disadvantage of that known method is that the opposed expansion of the plaster in the mold results in a substantial increase in the pressure in the mold. Since the element is unmolded by displacing one of the plates of the mold between the side walls of the mold, which are fixed with respect to each other, the force that has to be applied to the mold plate for unmolding has to be greater than the friction resulting from the pressure of the element on the side walls of the mold and is very high. Thus, to carry out said known method, very powerful presses have to be used, and they are very heavy and expensive. It may even become impossible to remove the elements from the molds without destroying them.

Further, since at least the major portion of the plaster sets in the mold, each mold is immobilized for a relatively long period prior to unmolding, which considerably decreases the manufacturing rate and means that a large number of molds has to be used; this is expensive.

The aim of the invention is to provide a method that can overcome the disadvantages of the known technique.

The invention also aims to provide a method that can produce elements of the type defined above with physical and mechanical properties that are equal to or are superior to those of elements produced using the known method.

To this end, the invention provides a method for manufacturing a building element based on plaster, said method consisting of placing at least plaster and water in a mold in the shape of the element to be obtained, compressing the mixture of plaster and water into the mold and unmolding the building element, characterized in that it also consists of applying to the mixture in the mold a pressure that is at least equal to a threshold value beyond which plaster crystallization is prevented by increasing its solubility in water, then causing rapid crystallization of the plaster by reducing the pressure applied to the mixture.

In a preferred implementation of the invention, the plaster is caused to crystallize by unmolding the element resulting from compression of the mixture in the mold, and allowing the plaster in the element to crystallize outside the mold.

It has been shown that when a mixture of plaster and water is subjected to a pressure that is greater than a certain limiting value, the solubility of the plaster in the water increases. If a mixture of plaster and water is prepared in proportions substantially corresponding to stoichiometric values for the plaster hydration and crystallization reaction, and if said crystallization is allowed to take place at atmospheric pressure, a volume expansion of the plaster and heating due to the heat released by the exothermic crystallization reaction is observed. When said mixture of plaster and water is subjected for several minutes to a pressure that is above atmospheric pressure, but below a certain threshold value, which is in the range approximately 100 to 150 bars at ambient temperature for a given plaster, plaster crystallization is not prevented, but its volume expansion is opposed, resulting in densification of the crystalline matrix of the plaster and a substantial improvement in the mechanical and physical qualities of the element obtained. If the mixture of plaster and water is subjected to a pressure that is above said threshold value, plaster crystallization is prevented as its solubility in water is increased, provided that the mixture contains a sufficient quantity of water to dissolve the plaster under pressure without saturating the solution. If the pressure applied to the mixture of plaster and water is then decreased, the solubility of the plaster decreases, causing very rapid crystallization.

It has been shown that by compressing a mixture of plaster and water in proportions of 35% to 40% by weight of water for 100% by weight of plaster at a pressure of about 150 bars in a mold at ambient temperature (about 20° C.) and by then rapidly unmolding the molded element, the plaster crystallizes extremely rapidly in the element.

In this method, unmolding of the element is easy and rapid as the plaster does not expand in the mold.

In a variation, said mixture of plaster and water can be compressed into the mold at a pressure of the order of 150 bars, then application of said pressure is stopped and the plaster is allowed to crystallize in the mold. However, more powerful means must be available in this case to extract the element from the mold following plaster crystallization.

Preferably, the compressed mixture in the mold comprises a filler, for example a granular filler.

It can be of any type that is chemically inert towards the plaster.

A light filler can be used with a density of close to 1, for example, for the manufacture of light strong elements, in particular tiles. The filler may be porous.

Sand of any type, building debris which has been ground, ground recovered material, etc can also be used.

It is also possible to use a filler that is not chemically inert towards the plaster, such as carbonates, phosphates, etc.

It is also possible to add recovered gypsum (phosphogypsum, sulphogypsum, borogypsum, etc) to the plaster.

In accordance with further feature of the invention, a fluidifier is added to said mixture, in particular a deflocculating product such as melamine.

This reduces the quantity of water required in the mixture to a minimum value while keeping the mixture sufficiently fluid to be homogeneously compressed into the mold. The advantage of reducing the quantity of water in the mixture is to reduce the final porosity of the manufactured element.

In accordance with a further feature of the invention, the method consists of initially compressing said mixture into the mold to reduce voids in the mixture to a minimum value or close to a minimum, then increasing the pressure applied to the mixture to at least said threshold value.

To increase said pressure, the invention advantageously envisages driving at least one element having a reduced cross section compared with the corresponding cross section of the cavity of the molding in the mold into the mixture. The pressure in the mold can then be increased while exerting a relatively low force on the end of the element.

Preferably, a plurality of said elements are used, which may, for example, be cylindrical rods guided in translation and sealingly mounted in orifices in one or more walls of the mold and to which axial thrust is applied.

Clearly, it is possible to use any other appropriate means known to the skilled person to increase the pressure inside the mold to a value above said threshold value by means of which the solubility of the plaster in water is increased, examples of said means being pressure multipliers, systems of levers, articulated systems, etc, of the type used in hydraulic presses.

The invention will be better understood and other characteristics, details and advantages of the invention will become apparent from the following description made with reference to the accompanying drawings in which:

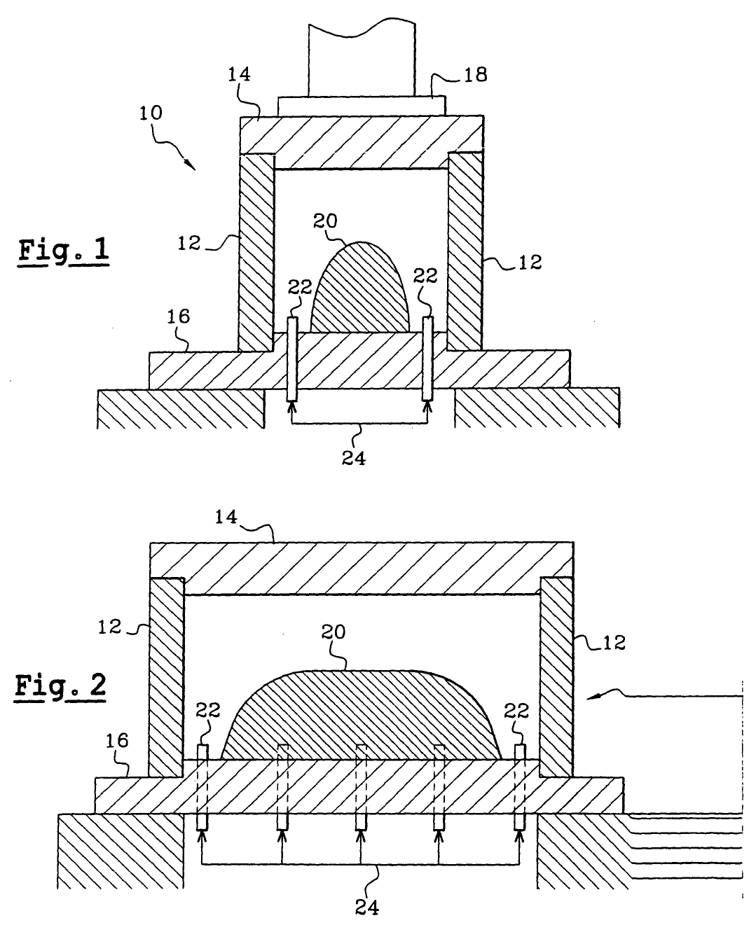

FIG. 1 is a diagrammatic cross section of a device for manufacturing a building element in accordance with the invention;

FIG. 2 is a diagrammatic axial cross section of the device of FIG. 1;

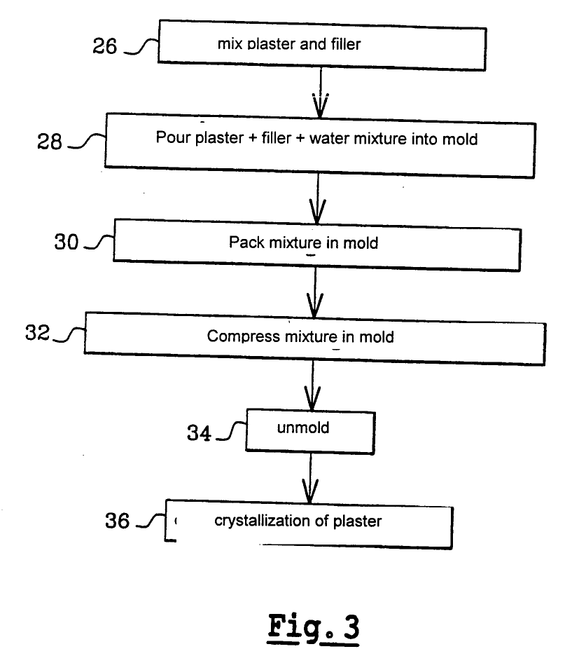

FIG. 3 is an organigram of the principal steps in the method of the invention.

In the embodiment shown in FIGS. 1 and 2, reference number 10 designates a mold for manufacturing a building element in accordance with the invention, said mold being in the shape of a rectangular parallelepiped and comprising four rigid, non-deformable side walls 12 permanently fixed together and an upper plate 14 and a lower plate 16 which are movably mounted with respect to the side walls 12.

The lower plate 16 rests on the table of a hydraulic press, while the upper plate 14 is associated with the movable plate of the press to be able to exert a compressive force on the mixture placed inside the mold 10.

Optionally, and as shown diagrammatically, the lower plate 16 may carry a projecting part 20 with a semi-oval shape, for example, intended to form a cavity in the element to be manufactured.

The mixture to be introduced into the mold 10 comprises plaster and a minimum quantity of water, substantially corresponding to twice the quantity of water required for the plaster hydration and crystallization reaction at atmospheric pressure.

In known manner, the plaster is a calcium sulfate semihydrate obtained by heating gypsum, which is a calcium sulfate dihydrate. Plaster that is currently commercially available comprises a certain number of additives, in particular set retarding agents. However, in the method of the invention, pure plaster can also be used, i.e., without an additive, or plaster of mediocre quality, containing non-calcined elements which form setting accelerators.

The mixture introduced into mold 10 also preferably comprises a granular filler such as sand, for example, or any other type of filler that is inert or chemically compatible with the plaster, as indicated above. The quantity of filler in the mixture can vary fairly widely, as can the granulometry of the filler. As an example, the mixture introduced into the mold may comprise about 30% to 50% by weight of plaster and about 70% to 50% by weight of filler. The quantity of water in said mixture depends on the temperature and on the compression threshold and is about 35 to 40 or even 45 parts by weight per 100 parts by weight of plaster in the majority of cases. Clearly, said values are given solely by way of example, to provide an idea, and can vary fairly widely as a function of the temperature and compression of the mixture in the mold. In a preferred implementation of the invention, the mixture contains 37 parts by weight of water per 100 parts by weight of plaster and is compressed to a pressure of 150 bars when the temperature is 20° C. to 25° C.

When manufacturing a building element in accordance with the invention, the following procedure is followed:

The upper plate 14 of the mold is withdrawn, and a mixture of plaster, filler and water in the proportions indicated above is poured into the mold mounted on the press. Preferably, the plaster and filler are dry mixed and the plaster hydration water is added at the last minute, for example when introducing the mixture into mold 10 or just prior thereto.

The next step consists of packing the mixture in the mold to eliminate as far as possible the air contained in the mixture and any excess water, which can escape via the clearance of a few hundredths to a few tenths of millimeters between the side walls 12 and the plates 14 and 16 of the mold. The packed mixture in the mold is compressed, for example by lowering the upper plate 14 of the mold to a predetermined depth substantially corresponding to the desired depth of the building element to be manufactured. Said depth is advantageous defined by abutment of the plate 14 on the side walls 12 of the mold.

The pressure applied to the mixture of plaster, filler and water in the mold is then increased to a threshold value beyond which the plaster is dissolved in the water. This limiting value depends on the temperature and also on the plaster used and is, for example, about 100 bars at 15° C., about 150 bars at 20-25° C., and 170-180 bars at 40° C. It suffices to compress the mixture in the mold to a pressure that is slightly higher than said threshold value, as application of a much higher pressure (for example twice the threshold value) only slightly affects the final result.

The consequence of said compression of the mixture in the mold and of an increase in the solubility of the plaster is that the plaster set is blocked and no plaster crystallization takes place in the mixture. This phenomenon can be explained as follows: plaster crystallization only occurs after the plaster dissolves in the water and the solution formed by the plaster and water is saturated to allow a calcium sulfate dihydrate germination-growth process to be initiated. Compression of the mixture in the mold above said threshold value has the effect of increasing the solubility of the plaster in the water and thus does not allow saturation of the solution, which would initiate said germination-growth process. Said compression is exerted for a time, for example about 10 to 15 seconds, sufficient for air and excess water in the mixture to be evacuated from the mold. On reducing or ending said compression, a state is reverted to in which the solubility of the plaster in water is lower, the solution then becomes saturated and brisk germination-growth is initiated with rapid crystallization of the plaster in the mixture in the form of small compact crystals that are substantially smaller than the crystals obtained during crystallization at atmospheric pressure.

In accordance with the invention, this pressure reduction is advantageously accomplished by unmolding the building element. Unmolding is carried out when the plaster has not yet set and is rendered possible as the high compression of the mixture in the mold produces a solid element. Unmolding is easy to accomplish, for example by lifting the upper plate and removing the side walls 12 of the mold, by vertical translation. The plaster in the unmolded element crystallizes rapidly at a rate which is typically a few minutes and is two to three times faster than the crystallization rate of plaster at atmospheric pressure in a mixture of stoichiometric proportions.

The elements that are manufactured have mechanical and physical characteristics that are comparable with or superior to those of dressed stone used in building. In particular, the compressive strength of an element of the invention is over 300 kg/cm².

Said elements can be used for building a few minutes after unmolding. Their dimensional accuracy means that they can be put together by stacking them on top of each other without joints and without external coatings, as described in the prior art cited above.

To reduce the porosity of said elements and improve their behavior towards water and gel, the mixture introduced into the mold contains a minimum quantity of water and a small quantity of a fluidifier, for example a deflocculant. Advantageously, said deflocculating agent is melamine in a quantity of less than 0.5% by weight with respect to the plaster.

The presence of said fluidifier can reduce to a minimum the quantity of water in the mixture while retaining sufficient fluidity of the mixture to allow it to be compressed into the mold substantially homogeneously and isostatically.

The means used to carry out the method of the invention can include a conventional hydraulic press with sufficient power to compress the mixture into the mold at a pressure of at least 150 bars.

It is also possible to use less powerful means that can, for example, compress the mixture into the mold at a pressure of the order of 80 bars, by combining them with other means such as those shown in FIGS. 1 and 2, which enable the pressure in the mold to be increased to a value of about 140 to 150 bars using a relatively low hydraulic power.

The means shown in FIGS. 1 and 2 include cylindrical rods 22 which are sealingly mounted in translation in orifices in the lower plate 16 of the mold and which are associated with thrust means to allow them to be introduced at least in part into the mixture compressed in the mold.

The following procedure is then followed:

The rods 22 are retracted and do not project into the interior of the mold; the desired quantity of said mixture is injected into the mold, packed and compressed to about 80 bars using the upper plate 14 of the mold. A thrust is then exerted on the lower ends of rods 22 to drive them at least partially into the mixture compressed in the mold.

Embedding the rods 22 into the mixture can increase the pressure on said mixture to a value of about 150 bars using a much lower thrust than if said internal pressure were obtained by displacing the upper plate 14 of the mold.

Driving the rods 22 into the mixture also compensates for small errors in dosing the mixture which can occur in practice. As an example, if the quantity of mixture introduced into the mold is slightly lower than the theoretical value, rods 22 will be driven further into the mixture to produce an internal pressure of about 150 bars. Conversely, if the quantity of mixture introduced into the mold is slightly higher than the theoretical value, the internal pressure of 150 bars in the mold will be reached by driving the rods 22 to a lesser extent.

Clearly, said rods can be mounted in orifices of the upper plate 14 of the mold and/or the short side walls 12 of the mold.

To facilitate unmolding, an opening mold can be used, i.e., a mold in which the side walls 12 are not rigidly fixed together and can be spaced apart from each other. In this case, the following procedure can be used:

The side walls of the mold are brought together at the sides of the element to be manufactured and are fixed in position. The procedure indicated above is then carried out by introducing the mixture into the mold, packing it and compressing it to about 150 bars. To unmold it, the upper plate 14 of the mold is withdrawn and the walls 12 are spaced away from each other laterally. The means for displacing walls 12 and for fixing said walls in position may be mechanical or hydraulic.

The principal steps of the method of the invention have been shown diagrammatically in the organigram of FIG. 3.

This organigram shows a step 26 for dry mixing plaster and filler, a step 28 for introducing the mixture of plaster, filler and water into the mold 10, a step 30 for packing the mixture into the mold, a step 32 for compressing the mixture into the mold at a pressure of the order of 150 bars, for example, a step 34 for unmolding the element obtained and a final step 36 in which the plaster is allowed to crystallize in the open air.

Step 30 lasts 10 to 15 seconds and step 32 lasts 20 to 30 seconds, for example, the progressive increase of the pressure between steps 30 and 32 allowing the constituents of the mixture to settle properly. The pressure is kept at the limiting value, in this instance 150 bars, for about 10 to 15 seconds, then is removed for unmolding; step 34 lasts about 15 seconds. The total duration of the compression and unmolding steps is about 60 seconds, giving the manufacturing rate per press and per mold (about 60 elements per hour).

The elements produced can be used for building a few minutes after being unmolded and are erected by being placed one on top of the other without joints because of their high dimensional accuracy. They become a coherent mass in a few minutes by pouring liquid plaster between the elements in known manner.

The building elements of the invention can have a shape and dimensions corresponding to that of conventional cement blocks. They can also have different shapes and dimensions depending on their destination. In particular, beams, lintels, slabs, panels, etc, can be formed.

1. A method for manufacturing a building element based on plaster, comprising placing at least plaster and water in a mold in the shape of the element to be obtained, compressing the mixture of plaster and water into the mold and unmolding the building element, and including steps of applying to the mixture in the mold a pressure that is at least equal to a threshold value beyond which plaster crystallization is prevented by increasing its solubility in water, then causing rapid crystallization of the plaster by reducing the pressure applied to the mixture.

2. A method according to claim 1, wherein the quantity of water in the mixture is substantially equal to twice the quantity of water necessary for crystallization of the plaster at atmospheric pressure and is 35 to 40 parts by weight of water per 100 parts by weight of plaster when the threshold compression value is about 150 bars.

3. A method according to claim 1, which includes causing crystallization of the plaster in the mixture by ceasing compression of the mixture.

4. A method according to claim 1, which includes causing crystallization of the plaster in the mixture by unmolding the element resulting from compression of the mixture into the mold.

5. A method according to claim 1, comprising crystallizing the plaster in the element outside the mold.

6. A method according to claim 1, comprising initially compressing the mixture in the mold to reduce voids in the mixture to a minimum value or close to a minimum, then increasing the pressure applied to the mixture to at least said threshold value.

7. A method according to claim 1, wherein the mixture in the mold comprises a granular filler.

8. A method according to claim 7, wherein the filler is chemically inert with respect to the plaster.

9. A method according to claim 7, wherein the filler is not chemically inert with respect to the plaster.

10. A method according to claim 1, wherein the mixture in the mold comprises a fluidifier.

11. A method according to claim 10, wherein the fluidifier is a deflocculating agent such as melamine.

12. A method according to claim 1, wherein said threshold value for the pressure increases with temperature and is in the range from about 100 to 150 bars when the temperature passes from about 15° C. to 20° C.

13. A method according to claim 1, wherein the application to the mixture in the mold of a pressure at least equal to that of said limiting value is accomplished by driving at least one element with a reduced cross section with respect to the corresponding cross section of the mold cavity into the mixture in the mold.

14. A method according to claim 11, wherein the deflocculating agent is melamine.

15. A method according to claim 13, wherein said element comprises a cylindrical rod sealingly mounted in an orifice of one wall of the mold, and including the step of guiding the rod axially in translation and driving it into the mixture.
